(19) United States
(12) Patent Application Publication
(10) Pub. No.: US 2010/0072900 A1
(43) Pub. Date: Mar. 25, 2010

(54) SYSTEM AND METHOD FOR GENERATING LIGHT BY COLOR MIXING

(75) Inventor: Carsten Deppe, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/439,230

(22) PCT Filed: Aug. 29, 2007
(86) PCT No.: PCT/IB2007/053469

§ 371 Date: May 1, 2009

(30) Foreign Application Priority Data
Sep. 6, 2006 (EP) 06120211.5

(51) Int. Cl. H05B 41/36

(52) U.S. Cl. 315/151

(57) ABSTRACT

The present invention relates to a method of generating light with a predetermined chromaticity value of a color gamut by color mixing of the light emitted by a plurality of light sources, each of which emits light with a primary color, the light sources being capable of emitting light with at least three primary colors, wherein at least a first and a second light source are used to emit light of at least one primary color. The object to provide a simple method of generating light with a predetermined and constant chromaticity value of a color gamut by color mixing of the light emitted by a plurality of light sources, which can even be advantageously used in display applications sequentially displaying primary colors, is achieved in that said first and said second light source emit light with different peak and/or dominant wavelengths, the chromaticity of the primary color generated by color mixing of the light emitted from said first and said second light source being adjusted to a predetermined and constant chromaticity value by controlling the ratio of intensities of said first and said second light source, and said chromaticity value of said primary-color light generated by color mixing is used to generate light by color mixing with the light of other primary color light sources.

### FIELD OF INVENTION

The present invention relates to a method of generating light with a predetermined chromaticity value of a color gamut by color mixing of the light emitted by a plurality of light sources, each of which emits light with a primary color, wherein the light sources are able to emit light with at least three primary colors and at least a first and a second light source are used to emit light of at least one primary color. Furthermore, the invention relates to a device for generating and emitting light with a predetermined chromaticity value of a color gamut by color mixing and to advantageous applications of the device.

### BACKGROUND OF THE INVENTION

The generation of light with a predetermined chromaticity value of a color gamut, for example white light, by color mixing of primary colors is well known in the prior art. In the present patent application the term “color gamut” is used for a two-dimensional area in the color space, the chromaticity values being achievable by color mixing of at least three light sources emitting light of different colors, i.e. light sources comprising different peak and/or dominant wavelengths. Several applications in which conventional light sources like bulbs are replaced by highly efficient single color emitting devices like light-emitting diodes (LEDs), organic light-emitting diodes (OLEDs,) or lasers, use the principles of color mixing to generate light with a predetermined chromaticity value. Usually, the generated light can be adjusted to a predetermined chromaticity value by controlling the operating state of each light source, i.e. of each LED. However, the light sources emitting primary-color light, for example LEDs, are subject to changes in their chromaticity value depending on parameters like temperature, current, voltage, and/or intensity. Thus, a change in the chromaticity value of the mixed-color light occurs, too. A lighting device emitting light with a constant chromaticity value is known from the published European patent application EP 1 643 227 A2. This lighting device uses a first and a second light source for emitting primary color light. In order to emit, for example, white light generated by color mixing with a predetermined chromaticity value, the above-mentioned European patent application discloses the use of a single sensor for measuring the intensity of each light source and adjusting the intensity emitted from each light source by means of pulse width modulation (PWM).

Due to the constant driving current or voltage within the duty cycle, the use of a PWM for controlling the light output of LEDs has the advantage that the LEDs emit light with a more or less constant chromaticity. On the one hand, the chromaticity values of the LEDs change with a variation of the temperature of the LEDs. On the other hand, the use of a PWM-controlled light source is not possible for display applications which generate the grey scale resolution by means of a PWM, like DLP-panels, since this would interfere with the control of the DLP-panel which uses a PWM to control the digital micromirror device (DMD). Also, the chromaticity values of LEDs depend on the operational conditions like current, voltage, and/or temperature. This leads to undesired changes in the chromaticity values of LEDs controlled by amplitude modulation. An adaptation of the intensity of light sources of displays by amplitude modulation is frequently desired to improve the contrast and the grey scale resolution of dark pictures, since the grey scale resolution of, for example, PWM-controlled displays is limited by the shortest circuit time possible of the PWM. Finally, the color gamuts of the known devices using LEDs as light sources, for example for display applications, are susceptible of improvement.

### SUMMARY OF THE INVENTION

Therefore, it is an object of the present invention to provide a simple method of generating light with a predetermined chromaticity value of a color gamut by color mixing of the light emitted by a plurality of light sources without a shift in the chromaticity value caused by a change in operating conditions.

According to a first teaching of the present invention, the above object is achieved by a method in which said first and said second light source emit light with different peak and/or dominant wavelengths, wherein the chromaticity value of the primary color generated by color mixing of the light emitted from said first and said second light source is adjusted to a predetermined chromaticity value by controlling of the ratio of intensities of said first and said second light source, and said chromaticity value of said primary-color light generated by color mixing is used to generate light by color mixing with the light of other primary-color light sources.

The inventive method prescribes that light is emitted by said first and said second light source, which have different peak and/or dominant wavelengths in one primary color. This results in different chromaticity values of the emitted light. However, light with a predetermined chromaticity value of one primary color can be provided by a color mixing in which the ratio of intensities of said first and second light source is adjusted. Since the chromaticity value of the generated light depends solely on the intensity ratio of said first and second light source, the control of this ratio can provide a predetermined chromaticity value of the light which is more or less independent of the operating status, i.e. of a change in the operating conditions, of each single light source. If the chromaticity values of the primary colors are held constant, the generation of, for example, white light with a predetermined chromaticity value is simplified. Merely the intensities of the primary colors have to be adapted to reach a predicted chromaticity value. A further advantage of the inventive method is that the chromaticity values of each single primary color can be adjusted to optimized values related to the color gamut needed for an application in that different dominant and/or peak wavelengths of said first and said second light source and different intensity ratios of said first and said second light source are chosen. This may obviously be done for all primary-color light, for example for the colors red, green, and blue. Hence, it is possible to match the color gamut almost exactly to the needs of the application. Finally, it is noted that in this patent application the term “primary color” usually defines the three primary colors red, green, and blue (RGB). However, since it is possible to use even primary colors like cyan, magenta, and yellow, these and other primary colors are included as well.

The sensitivity of the human eye has a maximum at the primary color green and decreases towards the primary colors blue and red. However, red or blue light-emitting LEDs often emit light which, for example, has chromaticity values extending beyond the color gamuts needed for an application. The human eye usually has a lower sensitivity for these extending chromaticity values. The overall efficiency of a lighting or display application as well as the adaptation to the color gamut can accordingly be improved by the inventive method in that the chromaticity value of at least one of the primary colors is adjusted by the ratio of the intensities of the dedicated light sources to a chromaticity value with a higher efficiency with respect to the human eye. Consequently, the energy consumption of, for example, a display application can be reduced while at the same time the maximum brightness of such a display application can be increased.

According to a further embodiment of the present invention, the light sources are light-emitting diodes (LEDs), LEDs from different bins being preferably used for each primary color. A bin contains a special selection of an LED depending on the dominant and/or peak wavelengths emitted and, for example, on the intensity of the specific LED. The amount of LEDs from one production run suitable, for example, for a display application can be increased by the use of LEDs from different bins for said first and said second light source, so the expense of providing a display unit is reduced. On the other hand, LEDs have a long lifetime and a high efficiency. In the present invention, furthermore, to take a LED from a “different bin” may even mean to choose a different type of LED if the chosen LED emits light with a different dominant and/or peak wavelength. Finally, it is possible to use organic light-emitting diodes (OLEDs) or other light sources like lasers or laser diodes with which the inventive method can also be implemented, since the latter light sources are known to provide a change in chromaticity that depends on the operating conditions.

A further advantageous embodiment of the invention is characterized in that the chromaticity value of at least one primary-color light is calculated from intensity measurements by means of at least one light sensor for at least said first and said second light source, considering constant chromaticity values for the respective light sources, the intensity of each light source being s measured within a predetermined time slot. For example, the time slot in which all other light sources are turned off may be chosen to measure the intensity of the light source immediately in a simple manner. However, in the predetermined time slot the light source itself may be turned off, and the intensity being calculated by a comparison with the intensity measured when every light source is turned on. This would maximize the turn-on time of all light sources, hence leading to a maximum intensity of an application when the inventive method is used. Furthermore, there are more complex methods possible to calculate the intensity by a measurement of intensities of the different LEDs.

According to another preferred embodiment of the inventive method, at least one wavelength-sensitive light sensor is used to determine the chromaticity value of one primary-color light, while preferably at least two wavelength-sensitive light sensors comprising different color filters are used to determine the chromaticity value of one primary-color light. In order to reduce the expense for a device realizing the inventive method, it is possible to determine the chromaticity value of the light of one of the primary colors by using only a single-wavelength-sensitive light sensor. However, a more precise determination of the chromaticity value of one primary-color light can be accomplished by using at least two wavelength-sensitive light sensors comprising different color filters. It is possible to calculate exactly the chromaticity value of the primary color light emitted by said first and said second light source from the characteristics of the color filters of the at least two wavelength-sensitive light sensors. In this case it is not necessary to measure the intensity of each light source of a primary color in a time slot while the other light sources are turned off.

To achieve a predetermined chromaticity value of the respective primary-color light according to a further embodiment of the inventive method, control means, preferably formed by at least one microcontroller, are used to control currents, voltages, and/or duty factors of at least said first and said second light source. The microcontroller has the additional advantage that it is possible to integrate the controller in a device with which the inventive method is implemented.

If the control means use control values at least of said first and said second light source stored in a memory of the control means and dependent on current, voltage, intensity, and/or temperature, it is possible to provide a fast control of the chromaticity to predicted values on the basis of the control values. This embodiment of the inventive method, furthermore, renders it possible to map the complex dependency of the chromaticity values of the respective light source on current, voltage, intensity, and/or temperature in a table of control values in the memory of the control means without using a complex feedback control algorithm. Hence, it is not necessary to use light sensors, in particular expensive wavelength-sensitive light sensors, for implementing the inventive method.

The control values of each light source used to generate primary colors with a predetermined chromaticity value can be stored in a look-up table in the memory of the control means, in order to accelerate an adjustment of the chromaticity value of the light source.

The dependency of the control values of each light source on currents, voltage, intensity, and/or temperature can be established in that the control values based on currents, voltage, intensity, and/or temperature of each light source are measured and stored after manufacture, during a switch-on procedure, on demand, and/or intermittently in a calibration process. It is possible to use high-quality equipment to calibrate the control values in such a process. A device using the inventive method is not operated during a switch-on procedure. A calibration on demand renders it possible to react, for example, to varying ambient conditions. Finally, an intermittent measurement would automatically consider changes in operating conditions of the light sources.

The inventive method may be further improved in that the intensities of the light sources are controlled by an amplitude modulation (AM) of the driving current or driving voltage. This preferred embodiment has the advantage that even display applications that already use a PWM to generate the grey scale resolution can use primary color emitting light sources like LEDs as light sources without a shift in the chromaticity values of the primary colors, since according to the inventive method the chromaticity value of each primary color is kept at the predetermined value.

According to a second teaching of the present invention, the above-mentioned object is achieved by a device for generating and emitting light with a predetermined chromaticity value of a color gamut by color mixing, comprising a plurality of light sources emitting light with primary colors, at least a first and a second light source for emitting one of the primary colors and control means enabling the inventive method for generating light by color mixing to be implemented.

With respect to the advantages of the inventive device for generating and emitting light by color mixing with a predetermined chromaticity value of a color gamut, reference is made to the disclosure relating to the inventive method. In view of the above, the inventive device is able to emit, for example, white light with a constant and predetermined chromaticity value of a color gamut with high efficiency. The inventive device is particularly suitable for use in display applications in which primary-color light is sequentially emitted.

Preferably, the inventive device comprises LEDs as light sources for emitting light with primary colors. More preferably, the primary colors are red, green, and blue. LEDs are efficient light sources with a long lifetime suitable for generating white light by color mixing. However, it is possible to use alternative primary-color light sources such as organic light-emitting diodes (OLEDs), lasers, and/or laser diodes.

According to an embodiment of the invention, the inventive device comprises at least one microcontroller, more preferably at least one microcontroller with a memory for storing control values of each light source. The microcontroller preferably comprises a memory for storing control values of each light source in order to permit a simple control of each light source in dependence on the stored control values. The control values may be generated immediately after manufacture through calibration of a device that implements the inventive method, so that the inventive device does not need any sensors.

Preferably, the inventive device comprises at least one light sensor, a current sensor, a voltage sensor, and/or a temperature sensor. A photo-diode, a photoresistor, a charge-coupled device, or a phototransistor may be used as the light sensor. The light sensor ensures a controlled light output and in particular a controlled chromaticity value of the generated light through color mixing in accordance with the inventive method. Preferably, wavelength-sensitive light sensors are used to determine the intensity and chromaticity of each light source or of the mixed-color light of a primary color. Current sensors, voltage sensors, and temperature sensors may also provide additional important information about the operating condition of each light source. All sensors can be used to set up a feedback control or to determine the control values.

Preferably, the control means of the inventive device are able to control the intensity of each light source through amplitude modulation of the driving current and/or the driving voltage. For example, the intensity of LEDs can easily be controlled through amplitude modulation of the forward current and/or forward voltages. The inventive device is in particular suitable for use in DLP-panels, since it provides an adaptation possibility of the intensity through amplitude modulation without a chromaticity shift and without interfering with the PWM used by a DLP-panel to generate the grey scale resolution.

Taking the advantages of the inventive method and of the inventive device into account the use of the inventive device in display applications, lighting applications, or signaling applications, preferably in DLP and LCD applications, more preferably in one-panel DLP or color sequential LCD applications, are advantageous. Reference is made to the advantages of the inventive method and of the inventive device as described above.

Finally, according to a last teaching of the present invention, the above-mentioned object is achieved by a DLP or LCD panel comprising an inventive device for generating and emitting white light with a predetermined chromaticity value. In particular, the inventive DLP or LCD panel ensures a highly efficient light output combined with an optimized color gamut of the lighting device for color mixing. The chromaticity value is kept constant independently of the operating status, whereby the operation of the inventive DLP- or LCD-Panel is optimized.

The present invention will be described below with reference to two embodiments and the drawings, in which:

### BRIEF DESCRIPTION OF THE DRAWINGS

FIG. 1 is a diagram showing the xy-color space with the locus of color values for monochromatic light sources together with a specified target color gamut and the color gamuts for of a typical LED arrangement with red, green, and blue LEDs known from the prior art,

FIGS. 2a, b) show two diagrams with cut-outs of the xy-color space in the area of the primary color red together with a color gamut provided by the inventive method for two different temperatures,

FIGS. 3a, b) comprise two diagrams of the color gamut provided by the inventive method in the area of the primary color blue for two different temperatures,

FIG. 4 schematically shows an inventive device comprising at least two different light sources for each primary color and means for controlling chromaticity values of the device, and

FIG. 5 schematically shows an embodiment of an inventive DLP-panel in which an inventive device is used.

### DETAILED DESCRIPTION OF THE EMBODIMENTS

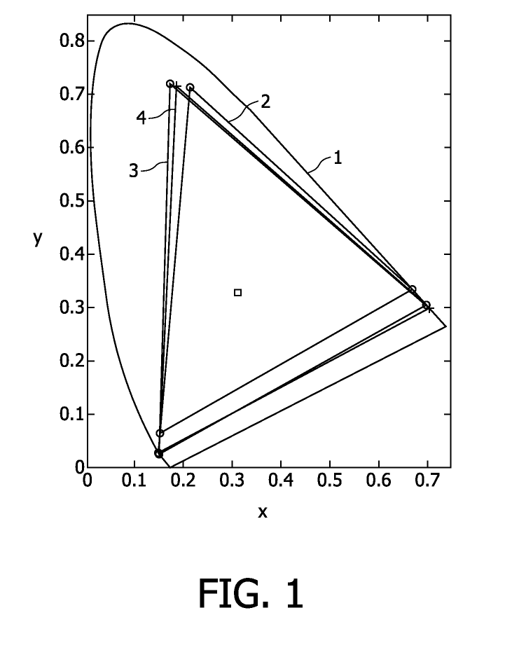

FIG. 1 is a diagram showing the xy-color space with the locus 1 showing the xy-chromaticity values of monochromatic light sources with wavelengths from 380 nm to 780 nm. Furthermore, a typical color gamut 2 of a display application is shown. The color gamut 2, however, is just one example of a possible desired color gamut. FIG. 1 additionally shows two further color gamuts 3, 4 of a typical device that generates light by color mixing using red, green, and blue LEDs for two different temperatures. The color gamut 3 represents the chromaticity values achievable with the lighting device at a temperature of 40 C, the color gamut 4 the chromaticity values achievable with the RGB arrangement of LEDs at 100 C in the xy-color space. As can be derived from FIG. 1, the color gamuts 3, 4 depend on the temperature and thus, as outlined above, make it difficult to provide a device or a method for generating light by color mixing in which a constant chromaticity value of the light, in particular of white light, is ensured independently of, for example, the temperature. However, other parameters affect the chromaticity values of light emitted from LEDs as well. These parameters are, for example, forward current, forward voltage, ambient temperature, and/or intensity. Since the LEDs usually used for these applications have different dominant and peak wavelengths at different temperatures, different driving currents, etc., it is difficult to achieve a constant chromaticity value of the generated light even with a complex feedback control algorithm known from the prior art.

Furthermore, it can be derived from FIG. 1, that the light-emitting diodes provide a color gamut which extends beyond the necessary color gamut 2 in the area of emitting the primary color blue (x-values from 0.1 to 0.2 and y-values of below 0.1) and in the range of the primary color red (x-values: 0.6 to 0.7 and y-values 0.2 to 0.4). As a result, the efficiency of such a lighting device is not optimized to the desired color gamut 2 and not even to the sensitivity of the human eye.

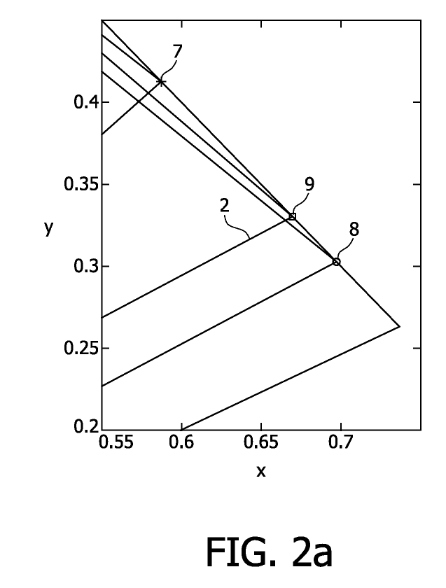

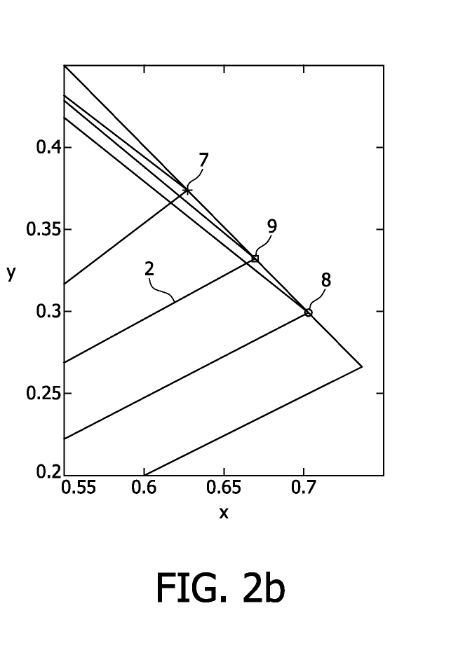

FIGS. 2a) and 2b) show the color gamut realized by an embodiment of the inventive method in a cut-off of the xy-color space for the range of the primary color red. As can be derived from FIG. 2a), the primary color red is generated by an LED that emits light with the color amber, which has a chromaticity value 7, and another light-emitting diode that emits the color red providing a second chromaticity value 8 on the locus in the xy-color space at a temperature of 40° C. To adapt the color gamut to the desired color gamut 2 in the area of the primary color red, the intensity of the amber LED is set to a factor of ⅓ of the intensity of the red LED. The primary-color light achieved by color mixing of the light of the amber LED and the red LED provides a chromaticity value 9, which exactly matches the color gamut 2.

If the temperature rises, the dominant and/or peak wavelengths of the amber and the red LED shift to higher values. As can be derived from FIG. 2b), however, adjusting the intensity of the amber LED to a factor of 0.76 of the red LED causes the chromaticity value to remain constant independently of the temperature. The inventive method renders it possible to react to shifting parameters with an adaptation of the ratio of the intensities of the first and second light sources so as to keep the chromaticity of the primary color constant.

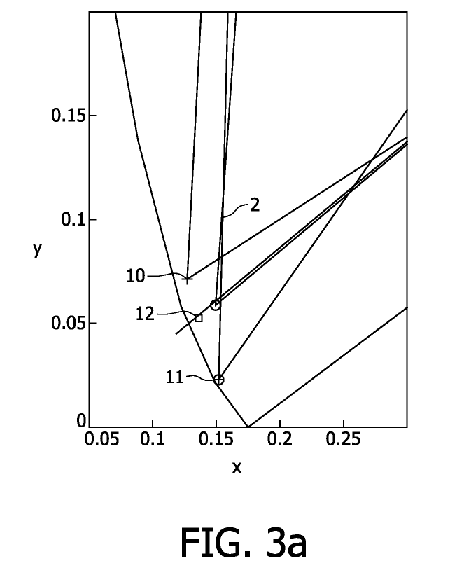

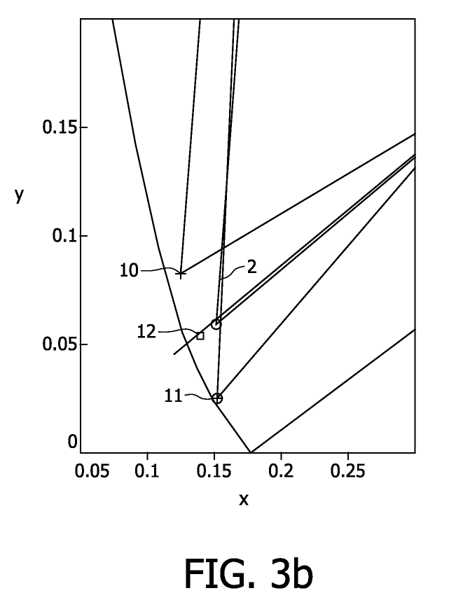

The same is achievable for the other primary colors like green and blue. By way of example, FIGS. 3a) and 3b) show the chromaticity values of two LEDs that emit blue-color light with different dominant and/or peak wavelengths, a first blue LED providing the chromaticity value 10 in the xy-color space and a second blue LED providing the chromaticity value 11 in the xy-color space. The mixed primary color blue resulting from color mixing of the emitted light of the two different blue LEDs has a chromaticity value 12 if the intensity of the LED with a higher peak wavelength is, for example, higher by a factor of 1.6 than the intensity of the blue LED emitting a lower peak wavelength. FIG. 3a) shows the chromaticity values at a temperature of 40° C. As can be derived from FIG. 3b), however, the same chromaticity value for the mixed primary color light can be achieved by the inventive method if the ratio of the intensities of the two different blue-color light-emitting LEDs is changed to a factor of 0.96, for example. The same is possible with two different green LEDs for the primary color green. Nevertheless, an accordant cut-off of the xy-color space in the range of the primary color green is not shown.

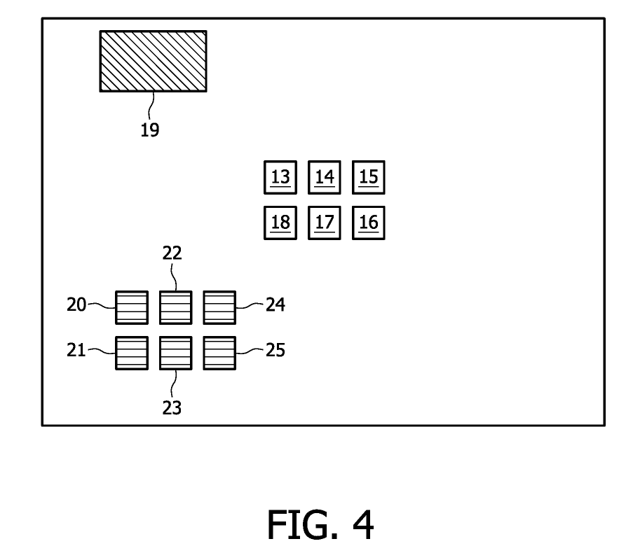

A schematic plan view of an embodiment of the inventive device is shown in FIG. 4. The embodiment of the inventive device comprises six different primary-color light sources, of which light sources 13, 14 emit blue light, light sources 15 and 16 emit green light, and light sources 17, 18 emit red light. Additionally, the inventive device comprises light sensors 20 to 25, which here are wavelength-sensitive in order to determine the chromaticity value of each light source 13, 14, 15, 16, 17, 18. A control means 19, which is preferably a microcontroller with a memory, uses the intensities measured by the wavelength-sensitive light sensors 20, 21, 22, 23, 24 and 25 to control the light output of each light source 13, 14, 15, 16, 17, 18. Preferably, the microcontroller 19 stores the chromaticity values in dependence on current, voltage, intensity, and/or temperature in a look-up table in its memory. A look-up table provides a fast access to the data for controlling each light source. In particular, as outlined above, the complex dependencies of current, voltage, intensity, and/or temperature can be mapped in a complex look-up table providing a high accuracy in color mixing. Although the embodiment of FIG. 4 shows that the microcontroller 19 and the light sensors 20, 21, 22, 23, 24 and 25 are integrated with the light sources 13,14, 15, 16, 17, 18 into one device, it is possible to arrange the microcontroller and/or the light sensors independently of the light sources.

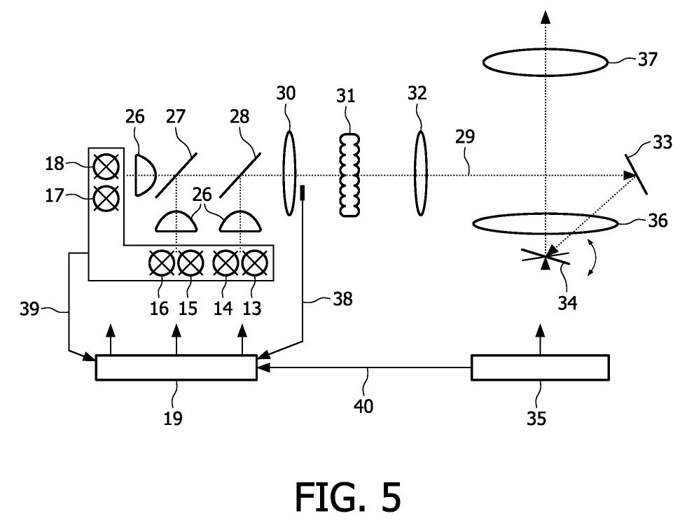

Since the above-mentioned embodiments of the present invention render it possible to improve the efficiency of primary light sources and to keep the color gamut, for example independently of the temperature, as was explained above, the described device is perfectly adapted to lighting applications, display applications, in particular in DLP panels or LCD panels sequentially emitting the primary colors. An embodiment of an inventive DLP panel using an inventive device is schematically shown in FIG. 5.

In FIG. 5, the LEDs 13,14,15,16,17 and 18 emit light with primary colors as in the embodiment of the inventive device in FIG. 4. The emitted light is collected by lenses 26 and dichroic mirrors 27, 28 in one optical path 29. Further optics 30, 31 and 32 are placed in the optical path 29 to collimate the light emitted by the LEDs. A further mirror 33 reflects the light onto a micro-mirrors device (DMD) 34, of which a single mirror is shown in FIG. 5. The DMD 34 is controlled by a graphic control unit 35, which processes graphic data into control signals for the DMD 34. The additional lenses 36 and 37 serve to focus the light reflected by the DMD 34, for example onto a screen, which is not shown.

As can be derived from FIG. 5, the display application uses only a single DMD 34 to display colored pictures. The LEDs 13 to 18 for this purpose have to emit their light sequentially, whereby a colored picture is generated owing to color mixing and the inertia of the human eye. To control the intensities of the individual colors, the DMD 34 is controlled by a PWM, such that the duty factor in the interval of each primary color determines the intensity of the primary color and therefore the chromaticity value achieved by color mixing. The microcontroller 19, however, controls, for example, the chromaticity value of each primary color generated by color mixing of the light of each primary-color light source. In the present embodiment, a light sensor 38 and a temperature sensor 29 provide the microcontroller with information about the operating conditions of the LEDs. Preferably, the light sensor 38 is a simple photodiode without a color filter so as to simplify the inventive DLP-panel. Depending on the information given, the microcontroller 19 chooses the ratio of currents or voltages stored in its memory relating to, for example, the LEDs 13 and 14, which emit the primary color blue, in order to adjust the chromaticity of the primary color blue to a predetermined value. Since the microcontroller 19 is able to control the light output of each LED through amplitude modulation, it is possible for the graphic control unit 35 to provide control signals 40 for the microcontroller 19 for adjusting the overall intensity of each primary color to the needs of the currently displayed picture. The grey scale resolution of the DLP can be increased in this manner.

1. Method of generating light with a predetermined chromaticity value of a color gamut by color mixing of the light emitted by a plurality of light sources, each light source emitting light of a primary color, such the light sources are capable of emitting light with at least three primary colors, wherein at least a first and a second light source of said plurality of light sources emit light of at least one primary color, said first and said second light source emit light with different peak and/or dominant wavelengths, wherein the chromaticity of the primary color generated by color mixing of the light emitted from said first and said second light source is adjusted to a predetermined chromaticity value through a control of the ratio of intensities of said first and said second light source, and said chromaticity value of said primary-color light generated by color mixing is used to generate light by color mixing with the light of other primary-color light sources, wherein the chromaticity value of at least one primary-color light is calculated from intensity measurements by at least one light sensor for said first and said second light source based at least in part on constant chromaticity values for the respective light sources, the intensity of each light source being measured within a predetermined time slot.

2. Method according to claim 1, wherein the chromaticity value at least of one of the primary colors is adjusted to a chromaticity value with a higher efficiency with respect to the human eye by means of the ratio of the intensities of the dedicated light sources.

3. Method according to claim 1, wherein the light sources are LEDs.

4. (canceled)

5. Method according claim 1, wherein at least one wavelength-sensitive light sensor is used to determine the chromaticity value of one light of the primary color, wherein at least two wavelength-sensitive light sensors comprising different color filters are used to determine the chromaticity value of one light of the primary color.

6. Method according claim 1, wherein currents, voltages, and/or duty factors of at least said first and said second light source are controlled by a microcontroller to achieve a predetermined chromaticity value of the respective primary-color light.

7. Method according to claim 6, wherein the microcontroller comprises a memory for storing control values at least of said first and said second light source.

8. Method according to claim 7, wherein control values of each light source used to generate primary-color light are stored in a look-up table in the memory.

9. (canceled)

10. Method according to claim 1, wherein the intensities of the light sources are controlled through amplitude modulation (AM) of the driving current or voltage of the light sources.

11-16. (canceled)
